(19) United States
(12) Patent Application Publication
(10) Pub. No.: US 2024/0238981 A1
(43) Pub. Date: Jul. 18, 2024

(54) Robot Device Configured to Determine an Interaction Machine Position of at Least One Element of a Predetermined Interaction Machine, and Method

(71) Applicant: Bayerische Motoren Werke Aktiengesellschaft, Muenchen (DE)

(72) Inventors: Thomas IRRENHAUSER, Muenchen (DE); Christian POSS, Birmingham (GB)

(21) Appl. No.: 18/558,772

(22) PCT Filed: May 11, 2022
(86) PCT No.: PCT/EP2022/062784

§ 371 Date: Nov. 3, 2023

(30) Foreign Application Priority Data
Jun. 2, 2021 (DE) 10 2021 114 264.4

(51) Int. Cl. B25J 9/16; B25J 19/02; G05B 19/418

(52) U.S. Cl. CPC B25J 9/1697; B25J 9/163; B25J 19/023; G05B 19/41815; G05B 2219/37097; G05B 2219/39039

(57) ABSTRACT

A robot device includes an optical detection device configured to detect a surrounding area image of an area surrounding the robot device. The robot device further includes a control device storing a predetermined reference marking and a predetermined reference position of the reference marking. The control device is configured to detect an image detail that shows the reference marking of the interaction machine in the surrounding area image of the area surrounding the robot device, detect the predetermined reference marking in the image detail, determine a distortion of the predetermined reference marking in the image detail, determine a spatial position of the reference marking, determine an interaction machine position of at least one element of the interaction machine with respect to the robot device from the spatial position of the reference marking, and subject the robot device to closed-loop control and/or open-loop control.

### BACKGROUND AND SUMMARY

The present subject matter relates to a robot device configured to determine an interaction machine position of at least one element of a predetermined interaction machine with respect to the robot device, and to a method for determining an interaction machine position of at least one element of a predetermined interaction machine with respect to a robot device.

In order to enable robot devices to interact with machines, it may be necessary for the robot devices to be manually trained. Typical interaction processes include, for example, removal of containers from a conveyor system or providing components for a machine. During such a training process, the robot device is taught an exact interaction machine position of the machine. This manual training phase is associated with a great deal of manual human effort. This additional effort is increased since it has to be repeated each time the position of the robot device in relation to the respective machine changes. This may be necessary, for example, if the robot device has to interact with several different machines.

U.S. Pat. No. 9,465,390 B2 discloses a fleet of robots which exhibit position control. This document describes that a control system is configured to identify a cooperative operation which is to be executed by a first robot device and a second robot device and is based on relative positioning between the first robot device and the second robot device. The first robot device and the second robot device are configured to perform a visual handshake which indicates the relative positioning between the first robot device and the second robot device for collaborative operation. The handshake may include mutual detection of visual markers of the robot devices.

U.S. Pat. No. 9,916,506 B1 discloses a control system which is configured to detect at least one position of an invisible fiducial marker on a robot device and to determine a position of the robot device.

It is therefore an object of the present subject matter to provide a solution which allows simple detection of interaction machines and their position for robot devices.

According to the present subject matter, this object is achieved by a robot device. Advantageous examples of the present subject matter are the subject matter of the dependent patent claims and the description, as well as the figures.

A first aspect of the present subject matter relates to a robot device which is configured to determine an interaction machine position of at least one element of a predetermined interaction machine with respect to the robot device. In other words, the robot device is designed to determine a position of the interaction machine or at least one element of the interaction machine. The robot device may be, for example, a transportation robot which is configured to accept objects from the interaction machine or to supply objects to the interaction machine. The interaction machine may be, for example, a conveyor belt or a mobile transportation robot which is intended to interact with the robot device. The at least one element may be, for example, a container, an arm or an output element of the interaction machine. The robot device is configured to detect a surrounding area image of an area surrounding the robot device by means of an optical detection device. The optical detection device may have, for example, cameras which can be configured to photograph the surrounding area image in the visible light spectrum, or else to take recordings in the infrared or ultraviolet range.

Provision is made for the robot device to have a control device. The control device may be, for example, an electronic component which can have a microprocessor and/or a microcontroller. A predetermined reference marking and a predetermined reference position of the reference marking with respect to the at least one element of the predetermined interaction machine are stored in the control device. In other words, the predetermined reference marking is stored in this control device, wherein the predetermined reference marking may be an optical marker which can be applied to the interaction machine or to the at least one element of the interaction machine. The predetermined reference position in which the reference marking is attached to the interaction machine is likewise stored in the control device. The control device is configured to detect a image detail, which shows the reference marking, of the interaction machine in the surrounding area image of the area surrounding the robot device. In other words, the robot device can determine an image detail, in which the reference marking is located, from the recorded surrounding area image. This may be done, for example, by means of simple detection of the interaction machine, wherein, in a second step, the image detail is created, this depicting a region of the interaction machine in which the predetermined reference marking is arranged. The control device is configured to detect the predetermined reference marking in the image detail and to determine a distortion of the predetermined reference marking in the image detail. In other words, the control device is configured to identify the reference marking in the image detail and to determine what distortion the identified reference marking in the image detail has. The control device is configured to determine a spatial position of the reference marking with respect to the robot device from the distortion of the reference marking. In other words, the detected distortion of the reference marking is used in order to determine the location at which the reference marking is located with respect to the robot device.

The spatial position may comprise, for example, a spacing or an orientation of the reference marking with respect to the robot device. The control device is set up to determine the interaction machine position of the interaction machine with respect to the robot device from the spatial position of the reference marking with respect to the robot device and the reference position of the reference marking with respect to the interaction machine. In other words, the control device is configured to determine the location at which the interaction machine or the at least one element of the interaction machine is located with respect to the robot device from the detected spatial position of the reference marking and the stored reference position, which indicates the location at which the reference marking is located on the predetermined interaction machine. The control device is configured to subject the robot device to closed-loop control and/or open-loop control for performing a predetermined interaction with the at least one element of the interaction machine in the interaction machine position.

The predetermined interaction may include, for example, placing a predetermined target object in a predetermined acceptance position of the interaction machine and/or picking up the predetermined target object from a predetermined placement position of the interaction machine. In other words, provision is made for the control device to use the derived interaction machine position in order to activate the robot device such that the predetermined interaction with the interaction machine is performed by the robot device. Particular provision can be made for the predetermined target object to be placed in the predetermined acceptance position of the interaction machine, or to be picked up from the predetermined placement position of the interaction machine. The predetermined target object may be, for example, a component of a motor vehicle that is intended to be placed in the predetermined acceptance position by the robot device.

The present subject matter results in the advantage that renewed training of the robot device is no longer necessary if the position of the interaction machine with respect to the robot device has changed. The processes to be performed have to be taught only once. The position of the interaction machine can be determined more easily and with fewer faults by indirect detection of the position of the interaction machine by means of the reference marking.

The present subject matter also comprises optional developments which result in further advantages.

One development of the present subject matter makes provision for the control device to be configured to detect the image detail and/or the distortion of the predetermined reference marking using machine learning methods. In other words, the control device is configured to detect the image detail in which the reference marking on the interaction machine is located and/or the distortion of the reference marking by means of applying machine learning methods. The machine learning methods may be, in particular, automatic image recognition by means of machine vision. In other words, by means of a form of artificial intelligence, machine learning, the image detail in which the reference marking is located is identified and furthermore the reference marking and its distortion are then determined in this region. The machine learning can be formed, for example, by an algorithm, in particular an algorithm with a learning capability. Owing to the use of machine learning, the method can be performed, for example, particularly advantageously and furthermore can be adapted to new reference markings and interaction machines in a simple manner.

One development of the present subject matter makes provision for the control device to be configured to apply the machine learning methods with inclusion of a neural network. Essentially two approaches can be followed during machine learning: firstly, symbolic approaches, such as propositional systems, in which the knowledge—both the examples and the induced rules—is explicitly represented, which can be expressed, for example, by the algorithm; and secondly, subsymbolic systems such as, in particular artificial, neural networks, which operate on the basis of the model of the human brain and in which the knowledge is implicitly represented. Combinations of the at least one algorithm and the at least one neural network are also conceivable here. The algorithm can have a learning capability, in particular a self-learning capability, and can be executed, for example, by the neural network, or the neural network receives instructions corresponding to the learning algorithm for predicting the algorithm and/or for identification and/or evaluation which can be implemented, for example, by means of pattern recognition which can be learnt by the neural network or the algorithm. This results in the advantage that the machine learning does not have to be carried out, for example, by an algorithm in a conventional processor architecture, but rather, on account of the use of the neural network, certain advantages can be produced during the recognition.

One development of the present subject matter makes provision for the reference marking to comprise a barcode and/or an area code. In other words, the reference marking has a region in the form of a barcode or has an area code, which may be a two-dimensional code. The two-dimensional code may be, in particular, an AprilTag, an ARTag, an ArUco or a QR code. The development results in the advantage that the reference marking has regions which are easy for the control device to recognize, the distortion of which reference marking can be easily and accurately determined by the electronic control unit. Owing to the use of a barcode and/or an area code, locations of the interaction machines can also be individually marked.

One development of the present subject matter makes provision for the predetermined interaction to comprise a transfer of the target object by the robot device to the interaction machine and/or a transfer of the target object by the interaction machine to the robot device. In other words, the control device is configured to activate the robot device in order to transfer the target object to the interaction machine and/or in order to accept the target object from the interaction machine during the interaction. The transfer can comprise, for example, grasping of the target object by the robot device at an outlet opening of the interaction machine. Provision can also be made for the robot device to be configured to accept a target object transferred by a gripper arm.

One development of the present subject matter makes provision for the predetermined interaction to comprise driving of the robot device onto and/or into the interaction machine. In other words, the control device is configured to activate the robot device such that it drives onto and/or into the interaction machine. For example, provision can be made for the interaction machine to be a lifting platform, a conveyor belt, a transportation vehicle or an elevator, the position of which can be derived by means of the reference marking. Provision can be made for the control device to be provided to detect the reference marking, so that the robot device can assume a predetermined position on the elevator during the predetermined interaction.

One development of the present subject matter makes provision for the robot device to be configured as a forklift truck. In other words, the robot device is a forklift truck. The forklift truck can be configured to lift, to transport or to lower the predetermined target object by means of forks. The robot device can be configured, in particular, to determine a point for holding or lifting the target object by means of the detected target object position.

One development of the present subject matter makes provision for the robot device to be configured as a gripper robot or crane. In other words, the robot device has a gripper arm or is configured as a crane. The robot device can be configured to grasp the target object in order to lift or move it.

One development of the present subject matter makes provision for the robot device to have an optical detection device which has at least two cameras. The cameras are each configured to generate the surrounding area image of the area surrounding the robot device from at least two partial images from the respective cameras, wherein the at least two cameras are configured to record the partial images from respective different perspectives. This results in the advantage that a larger surrounding area image is possible than would be possible with an optical detection device having just one camera.

A second aspect of the present subject matter relates to a method for determining an interaction machine position of a predetermined interaction machine with respect to a robot device. In the method, a surrounding area image of an area surrounding the robot device is detected by an optical detection device of the robot device. Provision is made for a predetermined reference marking and a predetermined reference position of the reference marking with respect to the predetermined interaction machine to be stored by a control device of the robot device. In a next step, an image detail, which shows the reference marking, of the interaction machine in the surrounding area image of the area surrounding the robot device is detected by the control device. Using the control device, the predetermined reference marking in the image detail is detected and a distortion of the predetermined reference marking in the image detail is determined. Using the control device, a spatial position of the reference marking with respect to the robot device is determined from the distortion of the reference marking and the interaction machine position of the interaction machine with respect to the robot device is determined from the spatial position of the reference marking with respect to the robot device and the reference position of the reference marking with respect to the interaction machine. Finally, using the control device, the robot device is subjected to closed-loop control and/or open-loop control in order to perform a predetermined interaction with the interaction machine by the robot device.

Further features of the present subject matter can be found in the claims, the figures and the description of the figures. The features and combinations of features cited above in the description and the features and combinations of features cited below in the description of the figures and/or shown in the figures alone can be used not only in the respectively indicated combination but also in other combinations or on their own.

### BRIEF DESCRIPTION OF THE DRAWINGS

FIG. 1 shows a schematic perspective view of a robot device according to the present subject matter.

FIG. 2 shows a flowchart of a method for determining an interaction machine position according to the present subject matter.

### DETAILED DESCRIPTION OF THE DRAWINGS

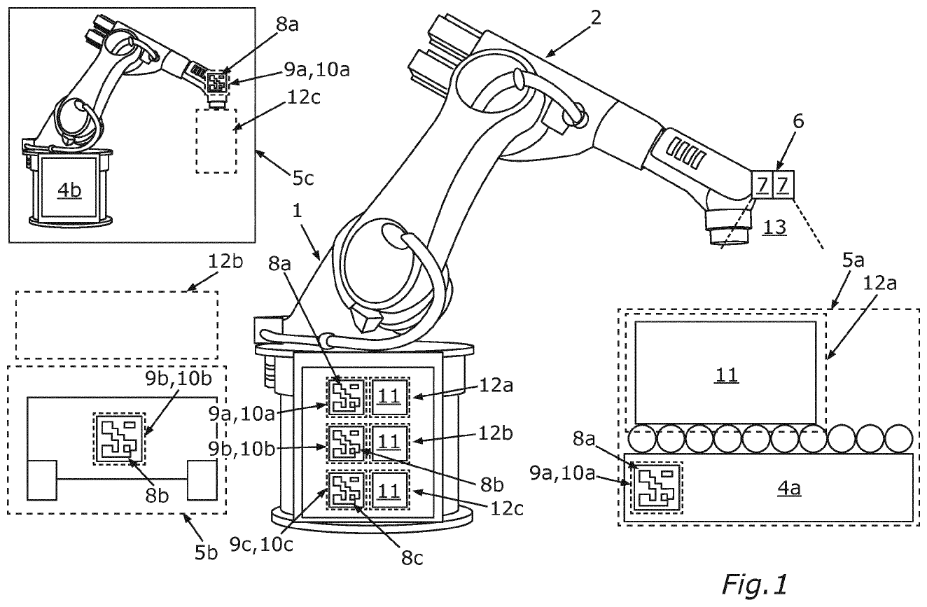

FIG. 1 shows a schematic illustration of a robot device. The robot device 1 can be provided, for example, to perform the predetermined interactions with the interaction machines 4 in a storage or production facility. The robot device 1 may be, for example, a forklift truck, or a gripper robot with a gripper arm 2. The robot device 1 can have a control device 3, wherein the control device may be an electronic device which can have a microprocessor and/or a microcontroller. The control device 3 can be configured to control the robot device 1. The interaction machines 4 may be, for example, a conveyor belt outlet 4a, a transportation robot 4b or another robot device 4c. Provision can be made for a respective interaction machine position 5 of the interaction machines 4 with respect to the robot device 1 to be able to change during operation. This can be done, for example, by moving the robot device 1 and/or the interaction machine 4. In order to be able to detect the surrounding area and therefore also the interaction machines 4a, 4b and their position 5a, 5b, the robot device 1 can have an optical detection device 6 which can have one or more cameras 7. The camera 7 can be configured to detect visible light, infrared or ultraviolet radiation. Since direct detection of the precise interaction machine position 5a, 5b of the interaction machines 4a, 4b can be computationally intensive and susceptible to faults, provision can be made to detect the interaction machine positions 5a, 5b of the interaction machines 4a, 4b indirectly. In order to enable indirect detection of the interaction machine positions 5a, 5b of the interaction machines 4a, 4b, provision can be made for each of the interaction machines 4a, 4b to be marked by a respective reference marking 8a, 8b. The reference markings 8a, 8b can be stored in the control device 3 of the robot device 1. Provision can be made for the reference markings 8a, 8b to be arranged in a respective reference position 9a, 9b with respect to the respective interaction machine 4a, 4b. In other words, provision can be made for the reference markings 8a, 8b to be arranged in a predetermined reference position 9a, 9b of the interaction machines 4a, 4b. The respective reference positions 9a, 9b can likewise be stored in the control device 3. Since the reference positions 9a, 9b can be known, the interaction machine position 5a, 5b of the respective interaction machine 4a, 4b can be derived in the event of detection and/or determination of the position of the respective reference markings 8a, 8b. For this purpose, provision can be made for a predetermined image detail, in which the respective reference marking 8a, 8b can be seen, from the surrounding area 13 to be selected by the control device 3. The control device 3 can identify the respective reference marking 8a, 8b and determine a distortion which results from the spatial position 10 of the reference marking 8a, 8b with respect to the optical detection device 6. The control device 3 can determine the spatial position 10a, 10b of the respective reference marking 8a, 8b with respect to the robot device 1 from the detected distortion. The control device 3 can determine which interaction machine position 5a, 5b the interaction machine 4a, 4b is located in with respect to the robot device 1 from the known spatial position 10a, 10b of the reference marking 8a, 8b and the reference position 9a, 9b. Owing to the indirect determination of the interaction machine position 5a, 5b, 5c by means of detecting the reference markings 8a, 8b, 8c, more precise and at the same time simpler determination of the position of the interaction machines 4a, 4b, 4c can take place than would be possible with direct determination of the interaction machine positions 5a, 5b by means of optically detecting the interaction machines 4a, 4b, 4c. This can be attributed, amongst other things, to efficient systems of reference markings 8a, 8b, 8c and algorithms for detecting the reference marking 8a, 8b, 8c already being available. The reference markings can also have one-dimensional or two-dimensional codes which can be kept in black and white. Therefore, the reference markings 8a, 8b, 8c can have simple and high-contrast patterns which allow simple determination of the distortion. The interactions can comprise, in particular, transfers of a target object 12. The robot device 1 can be either a transfer means or a receiving means for the target object 11 here. The target object 11 may be, for example, a component of a vehicle or a bundle. During the interaction, provision can be made for the target object to be intended to be received or passed over in a predetermined target object position 12a, 12b, 12c with respect to the interaction machine 4a, 4b, 4c by the robot device 1. The target object position 12a can be an end of an interaction machine 4a configured as a conveyor device, a placement region of an interaction machine 4b configured as a transportation robot or a holding region of an interaction machine 4c configured as a gripper robot.

Provision can also be made for the interaction machine position 5 to be able to relate to one or more elements of one of the interaction machines 4. For example, provision can be made for an interaction machine 4 which is designed as a gripper robot to have a reference marker 8 on a gripper arm 2 as the element in order to allow detection of the interaction machine position 5 with respect to the gripper arm 2 by the robot device 1. This can be advantageous, for example, if the robot device 1 is intended to transfer a target object 11 to the interaction machine 4c in such a way that the interaction machine 4c is intended to hold the target object in a predetermined target object position 12c by means of the gripper arm. For this purpose, it may be necessary for the robot device 1 to know the precise interaction machine position 5c of the gripper arm 2 and therefore allow a transfer of the target object 11 by the robot device 1.

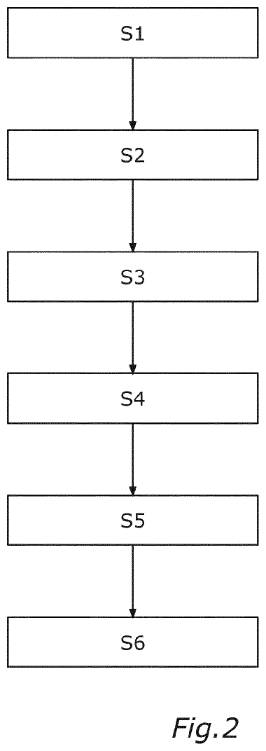

FIG. 2 shows a method for determining an interaction machine position 5 of a predetermined interaction machine 4 with respect to a robot device 1. In a first step, a predetermined reference marking 8 and a predetermined reference position 9 of the reference marking 8 with respect to the predetermined interaction machine 4 are stored in the control device 3 (S1). A surrounding area image 13 of an area surrounding the robot device 1 is detected by the optical detection device 6 of the robot device 1 (S2). Using the control device 3, the image detail, which shows the reference marking 8, of the interaction machine 4 in the surrounding area image 13 of the area surrounding the robot device 1 is detected (S3). Using the control device 3, the predetermined reference marking 8 in the image detail is detected, and a distortion of the predetermined reference marking 8 in the image detail is determined (S4). Using the control device 3, a spatial position 10a, 10b of the reference marking 8 with respect to the robot device 1 is determined from the distortion of the reference marking 8 (S5), and the interaction machine position 5 of the interaction machine 4 with respect to the robot device 1 is determined from the spatial position 10a, 10b of the reference marking 8 with respect to the robot device 1 and the reference position 9 of the reference marking 8 with respect to the interaction machine 4 (S6). Using the control device 3, the robot device 1 can be subjected to closed-loop control and/or open-loop control in order to perform a predetermined interaction with the interaction machine 4a by the control device 3.

1.-10. (canceled)

11. A robot device, comprising:
an optical detection device configured to detect a surrounding area image of an area surrounding the robot device; and
a control device in which a predetermined reference marking and a predetermined reference position of the reference marking with respect to at least one element of an interaction machine are stored, wherein the control device is configured to:
detect an image detail that shows the reference marking of the interaction machine in the surrounding area image of the area surrounding the robot device,
detect the predetermined reference marking in the image detail,
determine a distortion of the predetermined reference marking in the image detail,
determine a spatial position of the reference marking with respect to the robot device from the distortion of the reference marking,
determine an interaction machine position of at least one element of the interaction machine with respect to the robot device from the spatial position of the reference marking with respect to the robot device and the reference position of the reference marking with respect to the at least one element of the interaction machine, and
subject the robot device to closed-loop control and/or open-loop control for performing a predetermined interaction with the at least one element of the interaction machine in the interaction machine position.

12. The robot device according to claim 11, wherein
the control device is further configured to detect the image detail and/or the distortion of the predetermined reference marking using machine learning methods.

13. The robot device according to claim 12, wherein
the machine learning methods comprise a neural network.

14. The robot device according to claim 11, wherein
the reference marking is a barcode and/or an area code.

15. The robot device according to claim 11, wherein the predetermined interaction comprises:
a transfer of a target object by the robot device to the interaction machine, and/or
a transfer of the target object by the interaction machine to the robot device.

16. The robot device according to claim 11, wherein
the predetermined interaction comprises driving the robot device onto and/or into the interaction machine.

17. The robot device according to claim 11, wherein
the robot device is configured as a forklift truck.

18. The robot device according to claim 11, wherein
the robot device is configured as a gripper robot or crane.

19. The robot device according to claim 11, wherein
the optical detection device comprises two cameras configured to:
generate the surrounding area image of the area surrounding the robot device from at least two partial images from the respective cameras, and
record the partial images from different perspectives.

20. A method for determining an interaction machine position of at least one element of a predetermined interaction machine with respect to a robot device, the method comprising:
detecting, using an optical detection device of the robot device, a surrounding area image of an area surrounding the robot device;
storing, using a control device of the robot device, a predetermined reference marking and a predetermined reference position of the reference marking with respect to the at least one element of the predetermined interaction machine is stored;
detecting an image detail that shows the reference marking of the interaction machine in the surrounding area image of the area surrounding the robot device;
detecting the predetermined reference marking in the image detail is detected;
determining a distortion of the predetermined reference marking in the image detail;
determining a spatial position of the reference marking with respect to the robot device from the distortion of the reference marking;
determining the interaction machine position of the at least one element of the interaction machine with respect to the robot device from the spatial position of the reference marking with respect to the robot device and the reference position of the reference marking with respect to the at least one element of the interaction machine; and
subjecting the robot device to closed-loop control and/or open-loop control for performing a predetermined interaction with the at least one element of the interaction machine in the interaction machine position.
